(19) United States
(12) Patent Application Publication
(10) Pub. No.: US 2017/0293363 A1
(43) Pub. Date: Oct. 12, 2017

(54) System And Methods For Eye Gaze Triggered Control Of Appliance By Hand Gesture

(71) Applicant: Jeffrey Shawn McLaughlin, Hawthorne, CA (US)

(72) Inventor: Jeffrey Shawn McLaughlin, Hawthorne, CA (US)

(21) Appl. No.: 15/482,643

(22) Filed: Apr. 7, 2017

Related U.S. Application Data
(60) Provisional application No. 62/319,701, filed on Apr. 7, 2016.

(51) Int. Cl. G06F 3/01; G08C 17/02; G06K 9/00

(52) U.S. Cl. CPC G06F 3/017; G06K 9/00604; G06K 9/00355; G08C 17/02

(57) ABSTRACT

The herein disclosed systems and methods provide a user with an ability to control the operation of an appliance from a distance without needing to utilize an intermediary device encompassing multiple layers of graphical screen user interface or verbal dialog user interface. The present invention combines eye gaze recognition as a trigger with motion gesture recognition for appliance operation in a novel way to provide the user with a simple two-step procedure for operating an appliance at a distance.

An exemplary embodiment of the present system comprises a camera head unit including an eye gaze recognizing functionality receiving an eye gaze from a user and activating a hand gesture recognizing functionality, wherein the hand gesture recognizing functionality is receiving a hand gesture from the user and determining an operation based upon the hand gesture, and a communication device communicatively connected to the camera head unit and to the appliance for communicating the operation to the appliance. And exemplary embodiment of the present method for controlling an appliance from a distance comprises the steps of: receiving an eye gaze from a user; activating hand gesture recognition; receiving a hand gesture from the user; determining an operation based upon the hand gesture; and communicating the operation to the appliance.

### CROSS-REFERENCES TO RELATED APPLICATIONS

This non-provisional utility application takes priority to the previously filed provisional application: Application No. 62/319,701, filed 7 Apr. 2016, which is hereby incorporated in its entirety by reference.

### BRIEF DESCRIPTION OF THE INVENTION

The present invention is generally related to control of appliances from a distance without the user holding a physical device, and more particularly related to systems and methods for eye gaze triggered control of appliances by user hand gestures.

An exemplary embodiment of the present system comprises a camera head unit including an eye gaze recognizing functionality receiving an eye gaze from a user and activating a hand gesture recognizing functionality, wherein the hand gesture recognizing functionality is receiving a hand gesture from the user and determining an operation based upon the hand gesture, and a communication device communicatively connected to the camera head unit and to the appliance for communicating the operation to the appliance. And exemplary embodiment of the present method for controlling an appliance from a distance comprises the steps of: receiving an eye gaze from a user; activating hand gesture recognition; receiving a hand gesture from the user; determining an operation based upon the hand gesture; and communicating the operation to the appliance.

The herein disclosed systems and methods provide a user with an ability to control the operation of an appliance from a distance without needing to utilize an intermediary device encompassing multiple layers of graphical screen user interface or verbal dialog user interface. The present invention combines eye gaze recognition as a trigger with motion gesture recognition for appliance operation in a novel way to provide the user with a simple two-step procedure for operating an appliance at a distance.

### STATEMENTS AS TO THE RIGHTS TO INVENTIONS MADE UNDER FEDERALLY SPONSORED RESEARCH OR DEVELOPMENT

Not applicable.

### REFERENCE TO A “SEQUENCE LISTING,” A TABLE, OR A COMPUTER PROGRAM LISTING APPENDIX SUBMITTED ON A COMPACT DISK.

Not applicable.

### BACKGROUND OF THE INVENTION

The present invention is generally related to control of appliances from a distance without the user holding a physical device, and more particularly related to systems and methods for eye gaze triggered control of appliances by user hand gestures. Many systems and methods have been developed to allow a user to control devices from a distance, such as IOT (Internet of Things) devices and “smart” appliances. But the currently available systems and methods have many drawbacks.

Most home IOT devices or smart appliances are simply wifi-enabled appliances wherein the wifi-enablement allows a user to activate the appliance with an intermediary device such as a smart phone, a tablet or a voice-activated digital home assistant. These IOT and smart appliances do allow a user to operate the connected appliance from a distance, but the presently available solutions lack simplicity from the user's standpoint. A user of such a device must have access to the intermediary device in order to perform the remote operation. The user has to have his or her phone handy in order to turn off a smart light bulb, for example. Even if the user has access to the intermediary device, the user must then navigate several layers of on-screen user interface (UI). When using a smart phone as the intermediary device, at a minimum the user must select the appropriate app that controls the smart appliance, then select the desired appliance operation. Often even more steps are involved, such as entering security information, such as a pass code, to unlock the smart phone before the appropriate app can even be selected. When a voice-activated digital home assistant is the intermediary device, such as Amazon's Alexa or Google's Google Home, a back-and-forth conversation is required that often involves as many layers as the smart phone graphical ui, presenting much the same multi-layer UI problem (only without the screen).

Motion sensing devices are known. “Dumb” motion sensing devices have long been used outdoors to turn on flood lights outside homes. These devices are only able to operate in one direction—turning on when motion is detected. But they are not able to be turned off via motion. When used indoor, these dumb motion sensing devices are all too often accidently activated because they turn on for any motion.

Smarter motion gesture recognition systems are also known that have an ability to recognize, and respond to, more complex motion. For example, Microsoft's Kinect is a motion sensing input device for video game systems and personal computers. Intel's RealSense is another example. But these smarter motion gesture recognition systems do not provide for a simple two-step process for the user to operate the appliance. If used for controlling appliances, these known motion gesture recogniztion systems suffer from the multi-layer UI issue described above.

Eye gaze recognition is also well known. For example, smart phones are capable of tracking eye gaze in order to automatically stay on, as opposed to going to a sleep mode. Similar eye tracking is used for persons suffering from physically debilitating disabilities, to track their gaze for communication when viewing a computer monitor. And the ability to utilize a camera communicatively connected to a processor to recognize direct eye contact is known in the art. But because the known eye tracking systems are designed for persons with phycially debilitating disabilities, the eye tracking systems require detailed eye tracking in close proximity and do not combine this eye tracking with complex motion gesture recognition.

There is a need for a straightforward process, utilizing an elegant system, for remotely operating appliances without the use of intermediary devices so that the problem of multi-layer UI can be avoided. The present invention combines eye gaze recognition technology with motion gesture recognition technology to provide a user with a straightforward two-step process for remotely operating an appliance without the use of a multi-layer UI intermediary device.

### BRIEF DESCRIPTION OF THE SEVERAL VIEWS OF THE DRAWING

FIG. 1 illustrates a general overview of an exemplary embodiment of a system for eye gaze triggered control of an appliance by a user, as implemented with a standard dumb (non-smart) appliance in accordance with the present invention;

FIG. 2 illustrates an exemplary embodiment of a system for eye gaze triggered control of an appliance by a user, as implemented with a standard lamp for control at a distance by a user in accordance with the present invention; and

FIG. 3 is a schematic flowchart of an exemplary embodiment of a method for eye gaze triggered control of an appliance in accordance with the present invention.

### DETAILED DESCRIPTION OF THE INVENTION

The herein disclosed systems and methods provide a user with an ability to control the operation of an appliance from a distance without needing to utilize an intermediary device encompassing multiple layers of graphical screen user interface or verbal dialog user interface. The present invention combines eye gaze recognition as a trigger with motion gesture recognition for appliance operation in a novel way to provide the user with a simple two-step procedure for operating an appliance at a distance.

An exemplary embodiment of the present system comprises: a camera head unit including an eye gaze recognizing functionality receiving an eye gaze from a user and activating a hand gesture recognizing functionality, wherein the hand gesture recognizing functionality is receiving a hand gesture from the user and determining an operation based upon the hand gesture; and a communication device communicatively connected to the camera head unit and to the appliance for communicating the operation to the appliance.

An exemplary embodiment of the present method for controlling an appliance from a distance comprises the steps of: receiving an eye gaze from a user; activating hand gesture recognition; receiving a hand gesture from the user; determining an operation based upon the hand gesture; and communicating the operation to the appliance.

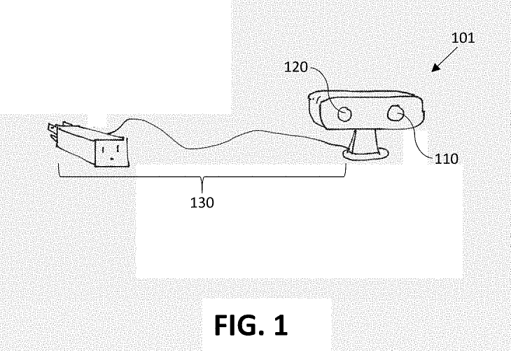

Referring to FIG. 1, an exemplary embodiment of the herein disclosed system for eye gaze triggered control of an appliance by a user, as implemented with a standard dumb (non-smart) appliance in accordance with the present invention, is illustrated. The system as shown in FIG. 1, for controlling an appliance at a distance, comprises camera head unit 101, including camera 110 and eye gaze signal 120, and communication device 130. Camera 110 may function both to receive an eye gaze from a user in order to provide an eye gaze functionality and to receive a hand gesture from a user in order to provide a hand gesture recognition functionality. Camera 110 is capable of both tracking eye gaze enough to determine whether a user has made direct eye contact with camera head unit 101 and recognizing hand gestures made by a user's body motion, as is known in the art of digital cameras. Camera 110 may in fact be two distinct cameras both communicatively connected to a processor within camera head unit 101, one digital camera for eye gaze recognition and one digital camera for hand gesture recognition.

The example shown in FIG. 1 is an embodiment for use with a standard “dumb” appliance, meaning an appliance lacking digital connectively, such as Wi-Fi, Bluetooth, or a direct line digital connection. In such a situation, communication device 130 may include a processor communicatively connected to a communication line running from camera head unit 101 to a power plug with a female receptacle. In this example, the camera head unit may communicate a turn-on operation to an appliance by communicating to the power plug to allow electrical power to run through the power plug to power an appliance plugged into the female receptacle. This example operates much like an external dimmer, in that the dumb appliance may be turned on or turned off by adjusting the power supply.

In other embodiments of the present system, communication device 130 may instead comprise a processor communicatively connected to a digital communication line running directly to an appliance's own processor, in the case of a “smart” appliance. Or, communication device 130 may comprise a processor communicatively connected to a wireless signal emitter, such as a WiFi device or a Bluetooth device as is known in the art. In such an example, communication device 130 is able to wirelessly transmit an operation to the appliance's own processor.

Eye gaze signal 120 may be a light, such as a light-emitting diode (LED), that activates (or turns on) when the eye gaze recognizing functionality of camera head unit 101 recognizes that the user has made direct eye contact with camera 110. The purpose of eye gaze signal 120 is to signal to the user that the user has indeed made direct eye contact with camera head unit 101, to indicate to the user that the present system is now activated to recognize and receive hand gestures from the user. In one exemplary embodiment, eye gaze signal 120 comprises one or more LEDs, or other light bulbs, and displays red light until the eye gaze functionality receives direct eye contact (an eye gaze), at which time eye gaze signal 120 then displays green light to signal to the user that the system is ready to receive hand gestures. In another embodiment, eye gaze signal 120 may instead be one or more speakers for emitting an eye gaze signaling audible sound.

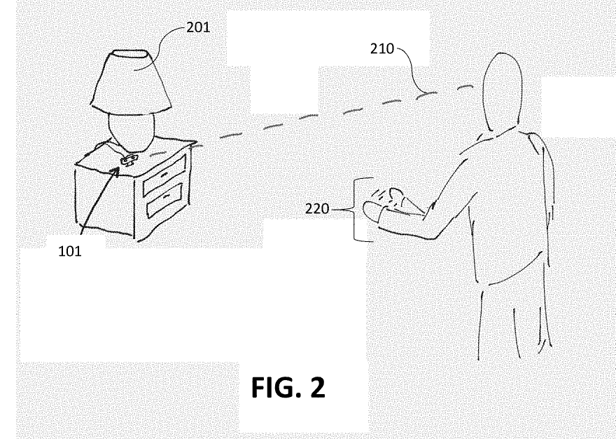

Referring to FIG. 2, an exemplary embodiment of a system for eye gaze triggered control of an appliance by a user, as implemented with a standard lamp for control at a distance by a user in accordance with the present invention is illustrated. In the example shown in FIG. 2, camera head unit 101 is communicatively connected to a standard dumb appliance (appliance 201) through a power plug with a female receptacle for receiving the power plug of appliance 201; in this case, appliance 201 is a lamp. The user can be seen making eye contact 210 with camera head unit 101, and then making gesture 220. Eye contact 210 may be an eye gaze directed by the user directly into camera head unit 101. Camera head unit 101's included eye gaze recognition functionality may be capable of tracking the user's eye movement from any location within a reasonable distance of camera head unit 101, as is known in the art. Camera head unit 101's eye gaze recognition functionality tracks the user's eye movement and makes a determination of whether it has received an eye gaze from the user. This determination is known in the art, and may involve tracking a time period of such a direct eye contact with the camera head unit 101, so that the determination of an eye gaze is only made if the eye contact lasts for a predetermined time period (such as half a second, for example). In an alternative embodiment, camera head unit 101 may be able to receive an eye gaze preference, such as an eye gaze time period, from the user during a configuration of the system. In this embodiment, the user is able to configure the system to the activate hand gesture recognition functionality only after the eye gaze, or eye contact, as be determined to last for a time period equal to or greater than the eye gaze time period as configured by the user.

Gesture 220 may include any sort of body motion gesture that is capable of recognition by the hand gesture recognizing functionality of camera head unit 101, as is known in the art. For example, the hand gesture recognizing functionality of camera head unit 101 may be able to recognize the user waiving his or her hand, and determine an operation for the appliance based upon the user waiving. Such recognition and determination of body gestures is known in the art and is currently utilized in other context for controlling video game systems and the like.

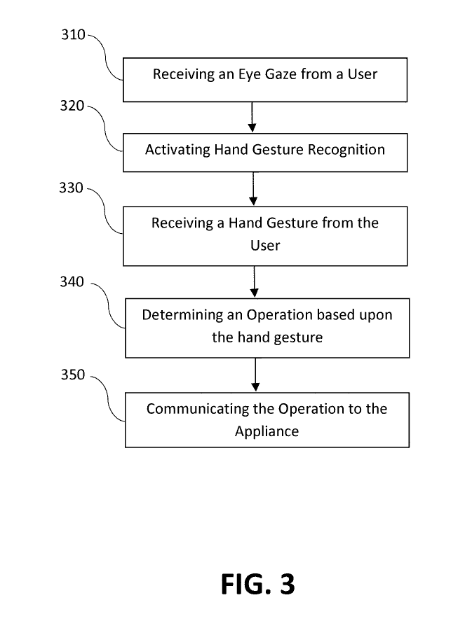

Referring to FIG. 3, an exemplary embodiment of a method for eye gaze triggered control of an appliance in accordance with the present invention, is illustrated. The method begins with step 310 receiving an eye gaze from a user. As discussed herein, an eye gaze may be direct eye contact by the user with camera head unit 101 for a predetermined length of time. Step 310 includes determining if the user's eye movement equals an eye gaze. If the system has received an eye gaze, then the method proceeds to step 320 activating hand gesture recognition. In step 320, hand gesture recognition is activated so that camera 110 may now recognize the user's body motion. Then, in step 330, a hand gesture is received from the user. In regard to step 330 (and the method in general) a hand gesture may include any body motion by the user that is capable of being recognized by motion gesture recognition, as is known in the art. For example, a hand gesture of step 330 may include a head nod by the user, or may include raising or lowering an arm. After a hand gesture has been received in step 330, step 340 involves a processor communicatively connected to camera head unit 101 (in an exemplary embodiment the processor is located physically within camera head unit 101) determining an operation for the appliance based upon the hand gesture received in step 330. Step 340 of determining an operation based upon the hand gesture may, for example, include comparing the hand gesture received to a predetermined set of established hand gestures stored within the camera head unit (or alternatively, stored within a memory communicatively connected to the camera head unit; such a memory may be located on appliance 201 if the appliance is a smart appliance). In an exemplary embodiment, the method may include a step of receiving a configuration from the user, wherein the configuration may include a eye gaze time period and may include a set of one or more established hand gestures and corresponding operations. Once the operation has been determined from the hand gesture in step 340, step 350 involves communicating the operation to the appliance.

As will be appreciated by those skilled in the art, step 350 communicating the operation to the appliance can take many forms, all of which are intended to be included herein. As illustrated in FIG. 1, step 350 may include communicating to the power plug with a female receptacle to attenuate the electrical power flowing through the power plug so that a dumb appliance may be turned off by reducing or eliminating the supply of electrical power to the appliance, for example. In an alternative embodiment, step 350 may include sending a WiFi signal to a smart appliance having a processor capable of communicating via WiFi; in this example, the WiFi signal includes the operation and thus the appliance will carry out the operation as directed by the user via the hand gesture received during step 330.

As is illustrated in FIG. 3, an exemplary embodiment of the herein disclosed system includes at least five steps (steps 310, 320, 330, 340, and 350). But from the user's perspective, only two steps are required to operate an appliance from a distance: making direct eye contact (which also may be referred to as an eye gaze) with the camera head unit, and then making a motion gesture with his or her body. From the user's perspective, the system and method are very easily utilized to control the appliance, without needing to wade through multiple layers of user interface.

In a streamlined alternative embodiment, appliance 201 may physically include camera head unit 101 and communication device 130. In this embodiment, the appliance itself would receive an eye gaze from the user via the included camera head unit 101 during step 310. The appliance itself, via a processor communicatively connected to the included camera head unit 101, would then activate hand gesture recognition in step 320, would receive a hand gesture from the user during step 330, would determine an operation based upon the hand gesture during step 340, and would then internally communicate the operation during step 350 by instructing itself to carry out the operation.

While the present invention has been illustrated and described herein in terms of a preferred embodiment and several alternatives, it is to be understood that the systems and methods described herein can have a multitude of additional uses and applications. Accordingly, the invention should not be limited to just the particular description and various drawing figures contained in this specification that merely illustrate a preferred embodiment and application of the principles of the invention.

What is claimed is:

1. A system for controlling an appliance at a distance, comprising:
a camera head unit including an eye gaze recognizing functionality receiving an eye gaze from a user and activating a hand gesture recognizing functionality, the hand gesture recognizing functionality receiving a hand gesture from the user and determining an operation based upon the hand gesture; and
a communication device communicatively connected to the camera head unit and to the appliance, for communicating the operation to the appliance.

2. The system for controlling an appliance at a distance as recited in claim 1, wherein the camera head unit includes an eye gaze signaling light.

3. The system for controlling an appliance at a distance as recited in claim 2, wherein the eye gaze signaling light displays red before an eye gaze is received by the eye gaze recognizing functionality and displays green after an eye gaze is received by the eye gaze recognizing functionality.

4. The system for controlling an appliance at a distance as recited in claim 1, wherein the camera head unit includes a speaker for emitting an eye gaze signaling audible sound.

5. The system for controlling an appliance at a distance as recited in claim 1, wherein the eye gaze is a predetermined eye gaze time period.

6. A method for controlling an appliance at a distance, comprising:
receiving an eye gaze from a user;
activating hand gesture recognition;
receiving a hand gesture from the user;
determining an operation based upon the hand gesture; and
communicating the operation to the appliance.

7. The method for controlling an appliance at a distance as recited in claim 6, wherein the step of activating hand gesture recognition includes signaling to the user that hand gesture recognition has been activated.

8. The method for controlling an appliance at a distance as recited in claim 7, wherein signaling includes changing a color of an eye gaze signaling light.

9. The method for controlling an appliance at a distance as recited in claim 7, wherein signaling includes turning on an eye gaze signaling light.

10. The method for controlling an appliance at a distance as recited in claim 7, wherein signaling includes emitting an audible sound.

11. The method for controlling an appliance at a distance as recited in claim 6, further comprising the step of receiving a predetermined eye gaze time period from the user.

12. The method for controlling an appliance at a distance as recited in claim 6, further comprising the step of receiving a configuration from the user.

13. The method for controlling an appliance at a distance as recited in claim 12, wherein the configuration includes an eye gaze time period.

14. The method for controlling an appliance at a distance as recited in claim 12, wherein the configuration includes an eye gaze time period and a set of established hand gestures and corresponding operations.
